(19) United States
(12) Patent Application Publication
(10) Pub. No.: US 2022/0335739 A1
(43) Pub. Date: Oct. 20, 2022

(54) CHARACTER AND SYMBOL RECOGNITION SYSTEM FOR VEHICLE SAFETY

(71) Applicants: Surbhi Bhatia, Hofuf (SA); Mohammad Tabrez Quasim, Bisha (SA); Shadab Alam, Jizan (SA); Mohammad Ayoub Khan, Bisha (SA); Pankaj Dadheech, Jaipur (IN); Swati Chandna, Heidelberg (DE); Riyaz Sheikh Abdullah, Jizan (SA); Gaurav Indra, Delhi (IN); D. Shanthi, Hyderabad (IN); Amit Kumar Tyagi, Chennai (IN)

(72) Inventors: Surbhi Bhatia, Hofuf (SA); Mohammad Tabrez Quasim, Bisha (SA); Shadab Alam, Jizan (SA); Mohammad Ayoub Khan, Bisha (SA); Pankaj Dadheech, Jaipur (IN); Swati Chandna, Heidelberg (DE); Riyaz Sheikh Abdullah, Jizan (SA); Gaurav Indra, Delhi (IN); D. Shanthi, Hyderabad (IN); Amit Kumar Tyagi, Chennai (IN)

(21) Appl. No.: 17/809,443

(22) Filed: Jun. 28, 2022

(51) Int. Cl. G06V 30/148; G06V 20/62; G06V 20/56; G06V 10/82; B60R 11/04

(52) U.S. Cl. CPC G06V 30/153; G06V 20/62; G06V 20/56; G06V 10/82; B60R 11/04

(57) ABSTRACT

The character and symbol recognition system comprises a detachable body having a photographic camera to capture real time image of one of sheet or poster comprising of printed and handwritten characters and symbols; an input unit to acquire the real time captured image; a pre-processing unit to detect a character and symbol region; a classification unit equipped with at least two channel neural network based on CNN and LSTM to separate the character and symbol region; a central processing unit to calculate weights for transitions to the candidates thereby generate one of a first character or first symbol string transition data based on a set of the candidates and the weights; and a control unit to detect one or both of the printed and handwritten characters and symbols thereby display the detected information on a display unit and play the detected information on a speaker to alert a rider.

### FIELD OF THE INVENTION

The present disclosure relates to digital character recognition, in more details, a character and symbol recognition system for vehicle safety.

### BACKGROUND OF THE INVENTION

In spite of the prevalence of technological media in today's world, a significant quantity of written communications, such as books, bank checks, contracts, and so on, is still done on paper. The automation of information extraction, classification, search, and retrieval of documents is becoming increasingly popular.

One of the first and most effective uses of pattern recognition was the recognition of printed characters using computers. For more than three decades, researchers have been working on optical character recognition (OCR). Hundreds of thousands of ways have been developed to deal with the recognition of machine-printed and handwritten characters in various scripts. The problem can be regarded solved for machine-printed Latin characters, at least when the degree of noise is modest. In cases where quality imagery is available, machine-printed character recognition rates often surpass 9%.

However, dealing with handwritten letters and sentences is tough, especially when the visuals are chaotic. Handwriting identification is tough due to the fact that there are as many different handwriting styles as there are persons. In fact, it's usually assumed that each person's handwriting is unique to them. Handwriting Identification is a forensic science subject that studies the identification or verification of the writer of a particular handwritten document. It is founded on the idea that no two people's handwritings are identical. This means that a handwritten character/word might assume an excessive number of different shapes, making identification difficult even for humans. In the view of the forgoing discussion, it is clearly portrayed that there is a need to have a character and symbol recognition system for vehicle safety.

### SUMMARY OF THE INVENTION

The present disclosure seeks to provide a character and symbol recognition system for guiding and alerting riders about road safety precautions.

In an embodiment, a character and symbol recognition system for vehicle safety is disclosed. The system includes a detachable body having a photographic camera installed on a top/front side of a vehicle to capture real time image of one of sheet or poster comprising of printed and handwritten characters and symbols. The system further includes an input unit connected to the photographic camera to acquire the real time captured image. The system further includes a pre-processing unit to detect a character and symbol region from the real time captured image. The system further includes a classification unit equipped with at least two channel neural network based on CNN (Convolutional Neural Network) and LSTM (Long- and Short-Term Memory Network) to separate the character and symbol region on a character-by-character basis and recognize the characters and symbols on character-by-character basis in separated regions and generate one or more character recognition and symbol recognition result candidates for each character and symbol. The system further includes a central processing unit coupled to the classification unit to receive the candidates and calculate weights for transitions to the candidates thereby generate one of a first character string transition data or a first symbol string transition data based on a set of the candidates and the weights, wherein consecutively perform state transitions based one of the first character string transition data or first symbol string transition data and collect the weights in each state transition to calculate a cumulative weight for each state transition for generating one or more state transition results signal based on the cumulative weight. The system further includes a control unit to receive the generated one or more state transition results signal to detect one or both of the printed and handwritten characters and symbols thereby display the detected information on a display unit and play the detected information on a speaker to alert a rider.

In another embodiment, the weights are revised on each of the candidates character size.

In another embodiment, the generated first character string transition data and first symbol string transition data comprises a first epsilon transition from an initial state of a character and symbol string transition to the candidate, a second epsilon transition from the candidate to a final state of the character and symbol string transition, and a third epsilon transition for skipping the candidate on a character-by-character basis.

In another embodiment, the separation of the character and symbol region is performed on at least two step upon deploying the at least two channel neural network based on CNN and LSTM to avoid any error.

In another embodiment, the output of both of the at least two channel neural network is compared and in case of any difference the separation of the character and symbol region is repeated to eliminate the error.

In another embodiment, the detected information is displayed and played to alert the rider about the instructions provided for the riders on the bank of the road to avoid accidents.

In another embodiment, the field of view of the photographic camera preferably ranges from 80° to 140°, which is optionally increased by deploying more cameras or camera with higher field of view.

In another embodiment, the pre-processing unit further comprises removal of margin, rule-line, noise and skew correction.

In another embodiment, a cloud server wirelessly connected to the control unit through a communication module to receive and store the detected information in multiple formats including images, text, and audio.

In another embodiment, the weights are calculated by taking character string transition data or the first symbol string transition data of pre-stored characters and symbols registered in a language database.

An object of the present disclosure is to perform character recognition from a scene image with high accuracy and at high speed.

Another object of the present disclosure is to guide and alert riders about road safety precautions.

Yet another object of the present invention is to deliver an expeditious and cost-effective character and symbol recognition system for vehicle safety.

To further clarify advantages and features of the present disclosure, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF FIGURES

These and other features, aspects, and advantages of the present disclosure will become better understood when the following detailed description is read with reference to the accompanying drawings in which like characters represent like parts throughout the drawings, wherein:

FIG. 1 illustrates a block diagram of a character and symbol recognition system for vehicle safety in accordance with an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

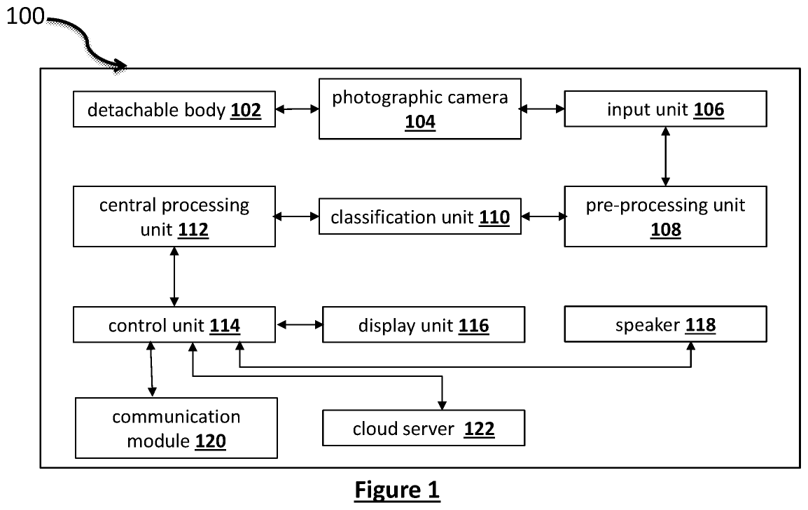

Referring to FIG. 1, a block diagram of a character and symbol recognition system for vehicle safety is illustrated in accordance with an embodiment of the present disclosure. The system 100 includes a detachable body 102 having a photographic camera 104 installed on a top/front side of a vehicle to capture real time image of one of sheet or poster comprising of printed and handwritten characters and symbols. The detachable body 102 can be attached with any of the vehicles including two-wheelers, four-wheelers or big trucks etc.

In an embodiment, an input unit 106 is connected to the photographic camera 104 to acquire the real time captured image.

In an embodiment, a pre-processing unit 108 is connected to the input unit 106 to detect a character and symbol region from the real time captured image. The pre-processing unit 108 further includes at least one operation selected from the group consisting of slant correction, binarization, vertical filling inside each connected components and removing isolated blocks.

In an embodiment, a classification unit 110 is equipped with at least two channel neural network based on CNN (Convolutional Neural Network) and LSTM (Long- and Short-Term Memory Network) to separate the character and symbol region on a character-by-character basis and recognize the characters and symbols on character-by-character basis in separated regions and generate one or more character recognition and symbol recognition result candidates for each character and symbol.

In an embodiment, a central processing unit 112 is coupled to the classification unit 110 to receive the candidates and calculate weights for transitions to the candidates thereby generate one of a first character string transition data or a first symbol string transition data based on a set of the candidates and the weights, wherein consecutively perform state transitions based one of the first character string transition data or first symbol string transition data and collect the weights in each state transition to calculate a cumulative weight for each state transition for generating one or more state transition results signal based on the cumulative weight.

In an embodiment, a control unit 114 is connected to the central processing unit 112 to receive the generated one or more state transition results signal to detect one or both of the printed and handwritten characters and symbols thereby display the detected information on a display unit 116 and play the detected information on a speaker 118 to alert a rider.

In an exemplary embodiment, the alert may include cautions about a sharp left turn, cautions the driver about a narrow road, indicates the driver about a narrow bridge on the road ahead, a sign indicates that pedestrians should cross the road and the like.

In another embodiment, the weights are revised on each of the candidates character size.

In another embodiment, the generated first character string transition data and first symbol string transition data comprises a first epsilon transition from an initial state of a character and symbol string transition to the candidate, a second epsilon transition from the candidate to a final state of the character and symbol string transition, and a third epsilon transition for skipping the candidate on a character-by-character basis.

In another embodiment, the separation of the character and symbol region is performed on at least two step upon deploying the at least two channel neural network based on CNN and LSTM to avoid any error.

In another embodiment, the output of both of the at least two channel neural network is compared and in case of any difference the separation of the character and symbol region is repeated to eliminate the error.

In another embodiment, the detected information is displayed and played to alert the rider about the instructions provided for the riders on the bank of the road to avoid accidents.

In another embodiment, the field of view of the photographic camera 104 preferably ranges from 80° to 140°, which is optionally increased by deploying more cameras or camera with higher field of view.

In another embodiment, the pre-processing unit 108 further comprises removal of margin, rule-line, noise and skew correction.

In another embodiment, a cloud server 122 wirelessly connected to the control unit 114 through a communication module 120 to receive and store the detected information in multiple formats including images, text, and audio.

In another embodiment, the weights are calculated by taking character string transition data or the first symbol string transition data of pre-stored characters and symbols registered in a language database.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A character and symbol recognition system for vehicle safety, the system comprises:
a detachable body having a photographic camera installed on a top/front side of a vehicle to capture real time image of one of sheet or poster comprising of printed and handwritten characters and symbols;
an input unit connected to the photographic camera to acquire the real time captured image;
a pre-processing unit to detect a character and symbol region from the real time captured image;
a classification unit equipped with at least two channel neural network based on CNN (Convolutional Neural Network) and LSTM (Long- and Short-Term Memory Network) to separate the character and symbol region on a character-by-character basis and recognize the characters and symbols on character-by-character basis in separated regions and generate one or more character recognition and symbol recognition result candidates for each character and symbol;
a central processing unit coupled to the classification unit to receive the candidates and calculate weights for transitions to the candidates thereby generate one of a first character string transition data or a first symbol string transition data based on a set of the candidates and the weights, wherein consecutively perform state transitions based one of the first character string transition data or first symbol string transition data and collect the weights in each state transition to calculate a cumulative weight for each state transition for generating one or more state transition results signal based on the cumulative weight; and
a control unit to receive the generated one or more state transition results signal to detect one or both of the printed and handwritten characters and symbols thereby display the detected information on a display unit and play the detected information on a speaker to alert a rider.

2. The system of claim 1, wherein the weights are revised on each of the candidates character size.

3. The system of claim 1, wherein the generated first character string transition data and first symbol string transition data comprises a first epsilon transition from an initial state of a character and symbol string transition to the candidate, a second epsilon transition from the candidate to a final state of the character and symbol string transition, and a third epsilon transition for skipping the candidate on a character-by-character basis.

4. The system of claim 1, wherein the separation of the character and symbol region is performed on at least two step upon deploying the at least two channel neural network based on CNN and LSTM to avoid any error.

5. The system of claim 1, wherein the output of both of the at least two channel neural network is compared and in case of any difference the separation of the character and symbol region is repeated to eliminate the error.

6. The system of claim 1, wherein the detected information is displayed and played to alert the rider about the instructions provided for the riders on the bank of the road to avoid accidents.

7. The system of claim 1, wherein the field of view of the photographic camera preferably ranges from 80° to 140°, which is optionally increased by deploying more cameras or camera with higher field of view.

8. The system of claim 1, wherein the pre-processing unit further comprises removal of margin, rule-line, noise and skew correction.

9. The system of claim 1, wherein a cloud server wirelessly connected to the control unit through a communication module to receive and store the detected information in multiple formats including images, text, and audio.

10. The system of claim 1, wherein the weights are calculated by taking character string transition data or the first symbol string transition data of pre-stored characters and symbols registered in a language database.
